(19) United States
(12) Patent Application Publication
(10) Pub. No.: US 2018/0188347 A1
(43) Pub. Date: Jul. 5, 2018

(54) VOICE DIRECTION SEARCHING SYSTEM AND METHOD THEREOF

(71) Applicant: YUTOU TECHNOLOGY (HANGZHOU) CO., LTD., Hangzhou City, Zhejiang (CN)

(72) Inventors: PENG GAO, Hangzhou City, Zhejiang (CN); Lichun FAN, Hangzhou City, Zhejiang (CN); Lei ZHU, Hangzhou City, Zhejiang (CN)

(73) Assignee: YUTOU TECHNOLOGY (HANGZHOU) CO., LTD., Hangzhou City, Zhejiang (CN)

(21) Appl. No.: 15/527,168

(22) PCT Filed: Feb. 20, 2017
(86) PCT No.: PCT/CN2017/074078

§ 371 Date: May 16, 2017

(30) Foreign Application Priority Data
Mar. 30, 2016 (CN) 201610192574.2

(51) Int. Cl. G01S 3/802; G01S 3/86

(52) U.S. Cl. CPC G01S 3/802; G01S 3/86

(57) ABSTRACT

The present invention relates to a technical field of voice interaction, especially to a voice direction searching system and the method thereof. The present invention utilizes a microphone array to collect voice signals made by an acoustic source, and utilizes multiple MEMS microphones to identify an MEMS microphone closest to the acoustic source, so that the voice direction searching system can accurately identify voice direction signals.

### CROSS-REFERENCE TO RELATED APPLICATIONS

The present application claims priority to and the benefit of Chinese Patent Application No. CN 201610192574.2, filed on Mar. 30, 2016, the entire content of which is incorporated herein by reference.

### BACKGROUND OF THE INVENTION

### 1. Field of the Invention

The invention relates to the field of voice interaction, more specifically, to a voice direction searching system and a method thereof.

### 2. Description of the Related Art

A voice recognition system needs to be operated to collect voice signals of users and recognize them. However, besides voice, noise inevitably exists in the environment, and the noise in the collected user's voice would have a serious influence on the accuracy of voice recognition. Accordingly, how to remove the noise is an important technical problem for a voice recognition system.

In the prior art, methods for removing noise usually comprise the use of a dual mic system for collecting voice samples and noise samples separately to filter so as to remove noise. However, the dual mic system can be used for handheld devices with a certain direction of the acoustic source only. If it is used for desktop devices, good denoising performance can not be obtained, therefore the correct direction of the acoustic source cannot be located.

### SUMMARY OF THE INVENTION

For solving the technical problems in the prior art, herein, the invention provides a voice direction searching system and the method thereof applied to a desktop voice recognition system.

The technical solution specifically comprises:

A voice direction searching system comprises:

a circular baseplate;

a microphone array, configured to collect voice signals, comprising at least eight MEMS microphones, wherein the at least eight MEMS microphones are disposed on circumference of the front side of the circular baseplate, and another MEMS microphone is disposed in the center of a corresponding circular baseplate;

an identification module, connected with each of the MEMS microphones, configured to identify the MEMS microphone closest to an acoustic source of the voice signal in the microphone array.

Preferably, in the voice direction searching system, any two adjacent MEMS microphones in the microphone array are distant equally.

Preferably, the voice direction searching system further comprises a support, the support is disposed on the back side of the circular baseplate, and configured to connect the circular baseplate into a housing; and a shockproof structure is positioned between the support and the circular baseplate.

Preferably, the voice direction searching system further comprises a processing module, connected with each of the MEMS microphones, and configured to process the voice signal to output sound signal.

More preferably, the voice direction searching system further comprises a speaker, connected with the processing module, and configured to play the sound signal.

Further more preferably, in the voice direction searching system, a distance between the speaker and the microphone array is above 20 cm.

Preferably, in the voice direction searching system, a radius of the circumference, disposed with the MEMS microphones, is more than 80 mm. Preferably, the voice direction searching system further comprises display modules, wherein the number of the display modules matches the number of the MEMS microphones;

the display modules are connected with the MEMS microphones correspondingly, and connected with the identification module; and

after the MEMS microphone closest to the acoustic source of the voice signal is identified, the identification module is further configured to control one of the display modules corresponding to the MEMS microphone closest to the acoustic source, to display corresponding information.

A method for searching voice direction includes:

Step 1: multiple MEMS microphones in the microphone array are used to collect voice signals;

Step 2: identifying the MEMS microphone closest to an acoustic source of the voice signals in the microphone array, so as to determine direction of the voice signal;

wherein, the microphone array comprises at least nine MEMS microphones, at least eight of the MEMS microphones are disposed on circumference, another MEMS microphone is disposed in a center corresponding to the circumference.

Preferably, the method for searching voice direction further includes Step 3 after Step 2, wherein Step 3 comprises:

Step 3: controlling a display module corresponding to the MEMS microphone closest to the acoustic source of the voice signal to display corresponding information.

The advantageous effects of the invention includes: the present invention utilizes a microphone array to collect voice signals made by an acoustic source, and utilizes multiple MEMS microphones to identify an MEMS microphone closest to the acoustic source, so that the voice direction searching system can accurately identify voice direction signals.

### BRIEF DESCRIPTIONS OF THE DRAWINGS

The accompanying drawings, together with the specification, illustrate exemplary embodiments of the present disclosure, and, together with the description, serve to explain the principles of the present invention.

FIG. 1 is a structure diagram of a voice direction searching system according to the invention.

FIG. 2 is another structure diagram of a voice direction searching system according to the invention.

FIG. 3 is a flow diagram of a method for searching voice direction according to the invention.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the term “plurality” means a number greater than one.

Hereinafter, certain exemplary embodiments according to the present disclosure will be described with reference to the accompanying drawings.

The embodiments with drawings shown here represent only examples of the present invention and may therefore not be understood to be limiting. Alternative embodiments that can be contemplated by the person skilled in the art are likewise included in the scope of the present invention.

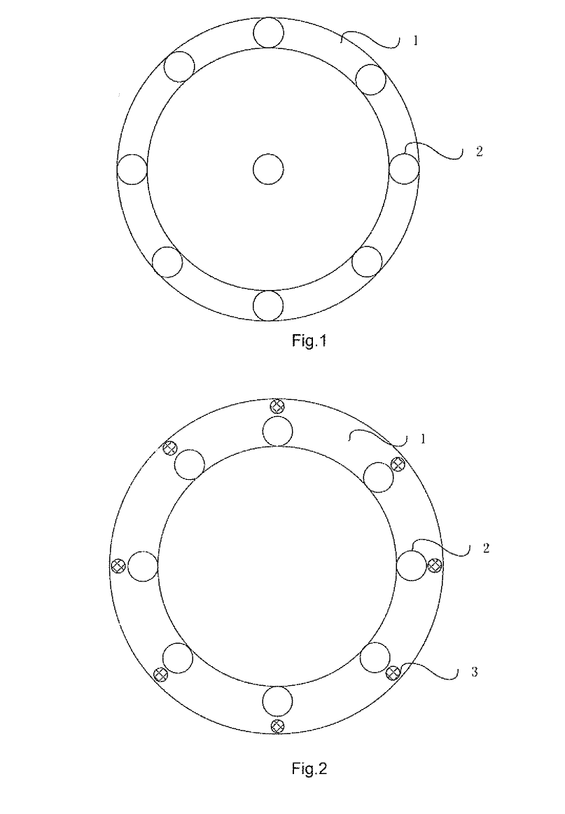

As shown in FIG. 1, there is provided a voice direction searching system in this embodiment, wherein it comprises:

a circular baseplate 1;

a microphone array, configured to collect voice signals, comprising at least eight MEMS (Micro Electro Mechanical System) microphones 2, wherein at least eight MEMS microphones 2 are disposed on circumference of the front side of the circular baseplate 1, and another MEMS microphone 2 is disposed in the corresponding center of the circular baseplate 1;

an identification module, connected with each of the MEMS microphones 2, configured to identify the MEMS microphone 2 closest to an acoustic source of the voice signal in the microphone array.

For instance, the identification module in the embodiment could recognize voice signal intensity for identifying and determining which MEMS microphone 2 of the microphone array is the closest to the acoustic source of the voice signal.

Additionally, the other MEMS microphones 2, except the MEMS microphone 2 closest to an acoustic source of the voice signal, may be switched off, so as to prevent the noise in the environment from being collected.

Furthermore, the other MEMS microphones 2, except the MEMS microphone 2 closest to an acoustic source of the voice signal and the one furthest from the acoustic source of the voice signal, may be switched off so as to form a dual mic system for collecting voice samples and noise samples separately, for the following noise filtering. In this case, the MEMS microphone 2 furthest from the acoustic source of the voice signal could be the one furthest from the MEMS microphone 2 which is closest to the acoustic source of the voice signal on the circular baseplate 1.

Nine MEMS microphones 2 in the microphone array shown in FIG. 1 is just a example, and the specific number of the MEMS microphones 2 may be arranged as required.

In a preferred embodiment of the present invention, any two adjacent MEMS microphones 2 in the microphone array are distant equally.

In this embodiment, the equal distance between any two adjacent MEMS microphones 2 is provided for improving the accuracy of the identification of the direction of the voice signal.

In a preferred embodiment of the present invention, the voice direction searching system further comprises a support, the support is disposed on the back side of the circular baseplate 1, and configured to connect the circular baseplate into a housing; and a shockproof structure is positioned between the support and the circular baseplate.

For instance, the shockproof structure in this embodiment could be a rubber pad, configured to prevent resonance of the MEMS microphones 2 caused by environment sound vibration, so as to avoid influence on adapterization effect.

In a preferred embodiment, the voice direction searching system further comprises a processing module, connected with each of the MEMS microphones 2, and configured to process the voice signal, so as to output sound signal.

In a more preferred embodiment, the voice direction searching system further comprises a speaker, connected with the processing module, and configured to play the sound signal.

In this embodiment, the processing module can convert voice signals to sound signals, and the speaker can output the sound signals, to achieve the playing of the voice signals.

In a further more preferred embodiment, a distance between the speaker and the microphone array is more than 20 cm.

In this embodiment, 20 cm may be the safe distance for signal interference. The distance between the speaker and the microphone is above 20 cm for avoiding interference between voice signals and sound signals.

In a preferred embodiment, a radius of the circumference, disposed with the MEMS microphones 2, is more than 80 mm.

In this embodiment, the MEMS microphones 2 disposed on the circumference with a radius more than 80 mm are convenient for the identification module identifying the direction of the MEMS microphone 2 closest to the acoustic source.

In a preferred embodiment, as shown in FIG. 2, the voice direction searching system further comprises: display modules 3, wherein number of the display modules matches number of the MEMS microphones 2; the display modules 3 are connected with the MEMS microphones 2 correspondingly, and connected with the identification module; and after the MEMS microphone 2 closest to the acoustic source of the voice signal is identified, the identification module is further configured to control one of the display modules 3 corresponding to the MEMS microphone 2 closest to the acoustic source, to display corresponding information.

For example, the display module in this embodiment may be LED (Light Emitting Diode). After the MEMS microphone 2, which is closest to the acoustic source, is identified, the identification module could switch on the LED corresponding to the MEMS microphone, so as to notify the user, therefore improving user experience.

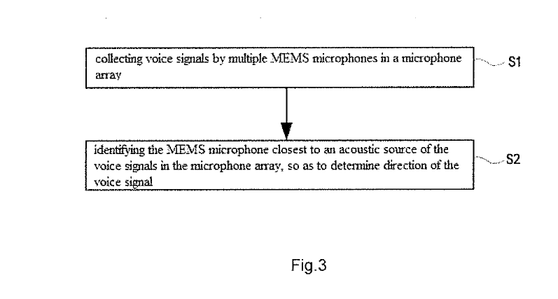

Furthermore, as shown in FIG. 3, there is provided a method for searching voice direction, wherein it includes:

Step 1: collecting voice signals by multiple MEMS microphones in a microphone array;

Step 2: identifying the MEMS microphone closest to an acoustic source of the voice signals in the microphone array, so as to determine direction of the voice signal;

wherein, the microphone array comprises at least nine MEMS microphones, at least eight of the MEMS microphones are disposed on the circumference, another MEMS microphone is disposed in the center of a circle corresponding to the circumference.

In a preferred embodiment, the method for searching voice direction further includes Step 3 after Step 2:

Step 3: controlling a display module corresponding to the MEMS microphone closest to the acoustic source of the voice signal to display corresponding information. In this embodiment, the arrangement of multiple MEMS microphones in the circumference is useful for identifying which MEMS microphone is the closest to the acoustic source of the voice signal.

In addition, after the MEMS microphone closest to the acoustic source is identified, one of the display modules corresponding to the MEMS microphone will display corresponding information; for example, the display module may be an LED; after the MEMS microphone closest to the acoustic source is determined, the LED corresponding to the MEMS microphone would be lightened.

In conclusion, the abovementioned technical solution utilizes a microphone array to collect voice signals made by an acoustic source, and utilizes multiple MEMS microphones to identify the MEMS microphone closest to the acoustic source, so that the voice direction searching system can accurately identify the voice direction signals.

The foregoing is only the preferred embodiments of the invention, not thus limiting embodiments and scope of the invention, those skilled in the art should be able to realize that the schemes obtained from the content of specification and figures of the invention are within the scope of the invention.

What is claimed is:

1. A voice direction searching system comprising:
a circular baseplate;
a microphone array, configured to collect voice signals, comprising at least eight MEMS microphones, wherein the at least eight MEMS microphones are disposed on circumference of a front side of the circular baseplate, and another MEMS microphone is disposed in a corresponding center of the circular baseplate;
an identification module, connected with each of the MEMS microphones, configured to identify the MEMS microphone closest to an acoustic source of the voice signal in the microphone array.

2. The voice direction searching system as claimed in claim 1, wherein any two adjacent MEMS microphones in the microphone array are distant equally.

3. The voice direction searching system as claimed in claim 1, further comprising a support disposed on a back side of the circular baseplate, and configured to connect the circular baseplate into a housing; and a shockproof structure is positioned between the support and the circular baseplate.

4. The voice direction searching system as claimed in claim 1, further comprising a processing module, connected with each of the MEMS microphones, and configured to process the voice signal to output sound signal.

5. The voice direction searching system as claimed in claim 4, further comprising a speaker, connected with the processing module, and configured to play the sound signal.

6. The voice direction searching system as claimed in claim 5, wherein a distance between the speaker and the microphone array is more than 20 cm.

7. The voice direction searching system as claimed in claim 1, wherein a radius of the circumference, disposed with the MEMS microphones, is more than 80 mm.

8. The voice direction searching system as claimed in claim 1, further comprising display modules, wherein number of the display modules matches number of the MEMS microphones; the display modules are connected with the MEMS microphones correspondingly and the identification module; and after the MEMS microphone closest to the acoustic source of the voice signal is identified, the identification module is further configured to control one of the display modules corresponding to the MEMS microphone closest to the acoustic source, to display corresponding information.

9. A method for searching voice direction, comprising:
Step 1: collecting voice signals by multiple MEMS microphones in a microphone array;
Step 2: identifying the MEMS microphone closest to an acoustic source of the voice signals in the microphone array, so as to determine direction of the voice signal;
wherein, the microphone array comprises at least nine MEMS microphones, at least eight of the MEMS microphones are disposed on circumference, another MEMS microphone is disposed in a center corresponding to the circumference.

10. The method for searching voice direction as claimed in claim 9, after Step 2, further comprising:
Step 3: controlling a display module corresponding to the MEMS microphone closest to the acoustic source of the voice signal to display corresponding information.
